(19) United States
(12) Patent Application Publication
(10) Pub. No.: US 2017/0002955 A1
(43) Pub. Date: Jan. 5, 2017

(54) Rotary Valve Seal Pressure and Indicator System

(71) Applicant: Prater Industries, Inc., Bolingbrook, IL (US)

(72) Inventor: William Boscarino, Palatine, IL (US)

(73) Assignee: Prater Industries, Inc., Bolingbrook, IL (US)

(21) Appl. No.: 15/198,357

(22) Filed: Jun. 30, 2016

Related U.S. Application Data
(60) Provisional application No. 62/186,522, filed on Jun. 30, 2015.

(51) Int. Cl. F16K 41/02

(52) U.S. Cl. CPC F16K 41/026

(57) ABSTRACT

A rotary valve is configured to control flow of particulate matter from a storage source into a conduit under pneumatic pressure. The valve comprises a cylindrical housing, opposing end plates partially enclosing said cylindrical housing, and a vaned rotor having opposing shafts protruding through annular seals provided in said end plates. At least one spring-loaded cartridge is adapted to exert a pre-determined pressure against said annular seals.

### CROSS-REFERENCE TO RELATED APPLICATION(S)

This application claims priority to and the benefit of U.S. Provisional Application No. 62/186,522, filed Jun. 30, 2015, the entire disclosure of which is hereby incorporated by reference herein.

### FIELD OF THE INVENTION

The invention pertains to improvements in rotary airlock valves, and in particular, to devices for applying even sealing forces within the seal system assembly of said valves.

### BACKGROUND OF THE INVENTION

Rotary valves for the transmission of dry particulate material are well known in the art. Rotary valves facilitate the transmission of a metered flow of dry particulate material into gravity fed or pressurized pneumatic conveying systems. Such conveying systems typically utilize gravity together with a flow of pressurized air through a conduit, thereby establishing a fluidized flow of material into the conduit, thereby moving the particulate material from one place to another.

Rotary valves typically include a cylindrical element into which a vaned rotor element is positioned. Openings in the top and bottom of the cylindrical element allow for the feed and discharge of granular material to and from the cylindrical cavity of the body of the valve. Generally, the cylindrical housing of the rotary valve defines an opening at the top for the introduction of particulate material and an opening at the bottom to discharge the particulate material flowing through the rotary valve into a pneumatic conveying system conduit. The cylindrical housing has supports allowing a vaned internal rotor to be mounted in such a fashion as to accommodate a transverse axis of rotation by the vaned rotor. Typically, the rotor is provided with a journal or shaft extending at opposing ends, and incorporates a plurality of planar radially extending vanes, which define chambers therebetween. The supported rotor is mounted to end plates that are affixed to or incorporated in the housing. Such mounts typically include bearings to facilitate rotation of the rotor. The rotor ends also penetrate seals at the opposing ends of the housing which prevent air leakage.

Because the interior of the valve may be pressurized, and because the valve assemblies are subject to continuous use, air leakage and improper adjustment of the seals is a common problem. In severe cases, leakage of air around or past the housing seals can degrade the performance of the valve assembly, affecting the differential pressures required to be maintained within the system, and resulting in uneven flow of the particulate material. Accordingly, air leakage reduces the operation efficiency, when the inter vane pockets of the rotor are not able to fill completely. Further, air leakage requires that the supplied air pressure for the pneumatic conveying system be increased to make up for the air loss sustained through the rotary valve seals. By maintenance of adequate sealing, pressurization requirements can be reduced and less energy will be utilized, saving operating costs.

Seal leakage problems can be reduced by insuring the application of uniform pressure to the seals, which at the same time results in decreased wear on the seal sets incorporated, when compared to currently known valve design configurations which do not address improperly or unevenly pressurized sealing arrangements.

### SUMMARY OF THE INVENTION

According to one aspect of the present disclosure, a rotary valve is configured to control flow of particulate matter from a storage source into a conduit under pneumatic pressure. The valve comprises a cylindrical housing, opposing end plates partially enclosing said cylindrical housing, and a vaned rotor having opposing shafts protruding through annular seals provided in said end plates. At least one spring-loaded cartridge is adapted to exert a pre-determined pressure against said annular seals.

According to another aspect, a rotary valve is provided controlling flow of particulate matter from a source to a conduit. The rotary valve includes a housing, a rotor, and a seal mechanism. The housings includes an inlet, an outlet positioned below the inlet, and a cavity between the inlet and the outlet. The rotor is positioned in the cavity of the housing, and includes a shaft about which the rotor rotates within the cavity. The seal mechanism includes a seal and one or more spring mechanisms that include a spring, wherein each spring mechanism is rotatable about an axis to compress the spring axially to urge the seal radially between the shaft and the housing.

According to another aspect of the present disclosure, a conveying system for particulate matter includes a rotary valve, a storage vessel, and a conduit. The storage vessel is coupled to and positioned above the rotary valve. The storage vessel being configured to contain particulate matter and supply the particulate matter to the rotary valve. The conduit is coupled to and positioned below the rotary valve. The conduit is configured to receive the particulate matter from the rotary valve. The rotary valve includes a housing, a rotor, and a seal mechanism. The housing includes a top opening for receiving the particulate matter from the storage vessel, a bottom opening for supply the particulate matter to the conduit, and a cavity. The rotor includes a shaft and a plurality of radially extending vanes, and is configured to rotate about the shaft. The seal mechanism seals the shaft to the housing. The seal mechanism includes a seal and a plurality of spring mechanisms distributed about the seal to compress the seal in an axial direction with substantially even force to urge the seal radially outward against the housing and radially inward against the shaft.

It is an object of the invention to overcome the above disadvantages by providing rotary valve end plates which provide even sealing pressure by utilizing an adjustable packing gland nut in relation to a captive seal assembly to reduce air leakage through the rotary valve.

It is a further object of the invention to provide compact, self-contained, adjustable pressurized cartridges to the rotary valve end plates.

It is a further object of the invention to incorporate a low profile energizing spring in cooperation with a cartridge element which provides a visual indicator of applied pressure.

It is a further object of the invention to provide a source of evenly applied pressure on the valve body seals.

It is a further object of the invention to provide the ability to vary the cartridge spring pressure to allow for adjustment of the pressure applied by the cartridge to accommodate different materials and applications.

It is a further object of the present invention to provide a tool-engaging surface to permit quick adjustment of the cartridge without the need for custom tooling.

It is a further object of this invention to provide cartridge components having smooth round or transitional surfaces approved by regulatory agencies as cleanable for sanitary equipment applications.

### BRIEF DESCRIPTION OF THE DRAWINGS

These and other objects of the present invention will be best understood by reference to the following description and drawings, in which:

FIG. 1 is a diagrammatic view of a conveying system utilizing a rotary valve of the invention described herein.

FIG. 2A is an exploded perspective view of a rotary valve assembly of the invention.

FIG. 2B is a perspective view of the rotary valve assembly of FIG. 2A.

FIG. 2C is a partial perspective view of rotary valve of FIG. 2A, which is shown in a service configuration with a vaned rotor extracted from a housing.

FIG. 3A is an exploded perspective view of the pressure cartridge of the rotary valve assembly shown in FIG. 2A.

FIG. 3B is a top view of the pressure cartridge of FIG. 3A.

FIG. 3C is a cross-sectional view of the pressure cartridge taken along line 3C-3C in FIG. 3B, which is shown in a de-energized condition.

FIG. 3D is another cross-sectional view of the pressure cartridge of the pressure cartridge taken along line 3D-3D in FIG. 3B, which is shown in a fully energized condition.

FIG. 4A is a partial cross-sectional view of the rotary valve assembly taken through an axis of rotation of a rotor along line 4A-4A in FIG. 2B.

FIG. 4B is another partial cross-sectional view taken through the axis of rotation of the rotor along line 4B-4B in FIG. 2B.

FIG. 5 is another partial cross-sectional view of the rotary valve assembly of FIG. 2A.

### DETAILED DESCRIPTION OF THE EMBODIMENT

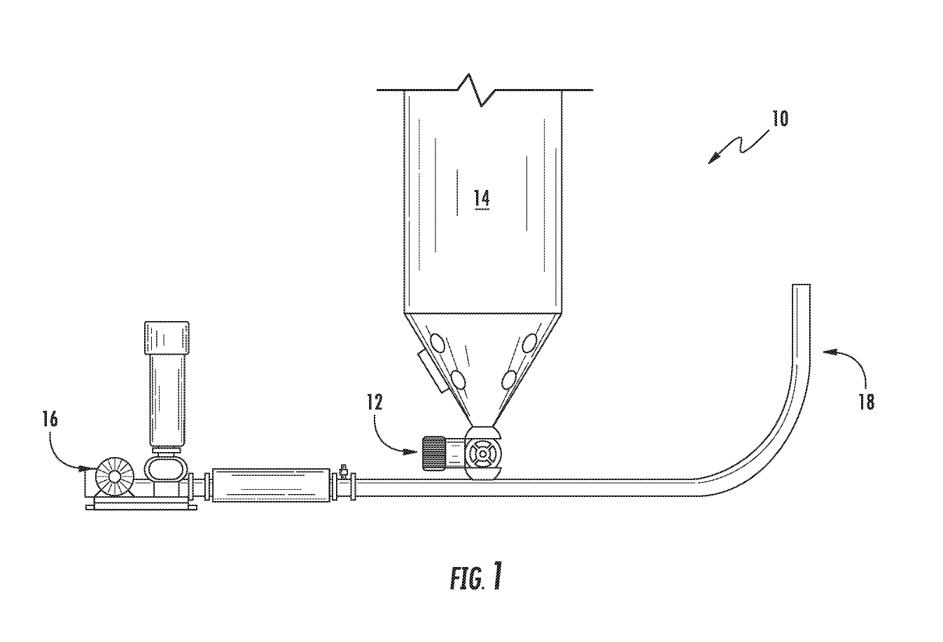

The significance of the present invention will best be appreciated by first referring to FIG. 1. In the typical environment for the conveyance of dry, free-flowing powders, granules, crystals, pellets and the like, a conveying system is provided. The conveying system 10 of the present invention utilizes a rotary valve 12 to control the flow of particulate material from a storage vessel 14 (e.g., storage source) into a conduit 18, under the influence of air pressure provided by a blower 16. It is desirable to insure that the air pressure provided by the blower 16 is utilized to efficiently move the particulate matter into and through conduit 18, and to minimize air leakage from the rotary valve 12 into the storage vessel 14, and to likewise minimize leakage of air and particulate matter from the rotary valve 12 into the surrounding environment.

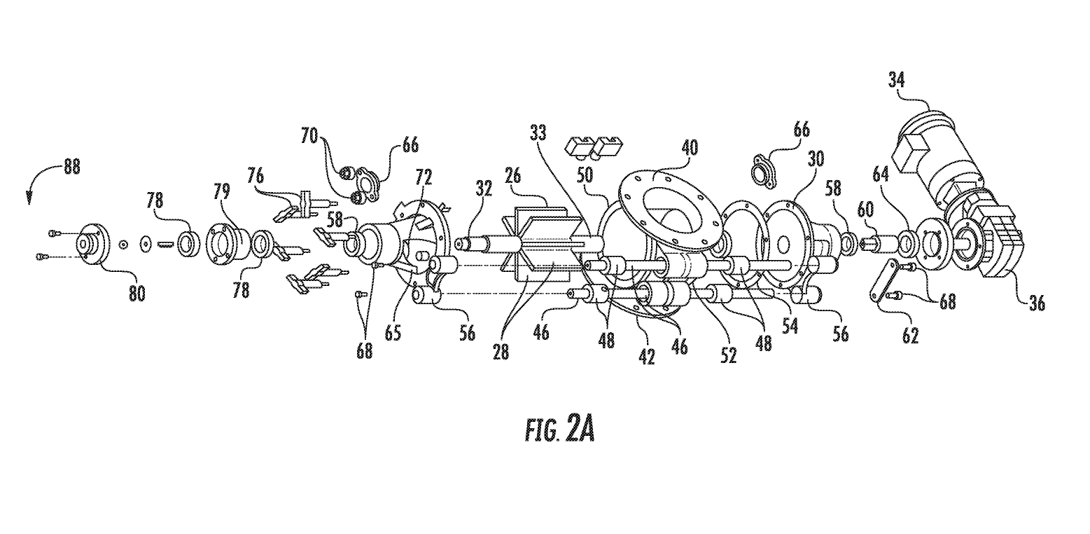

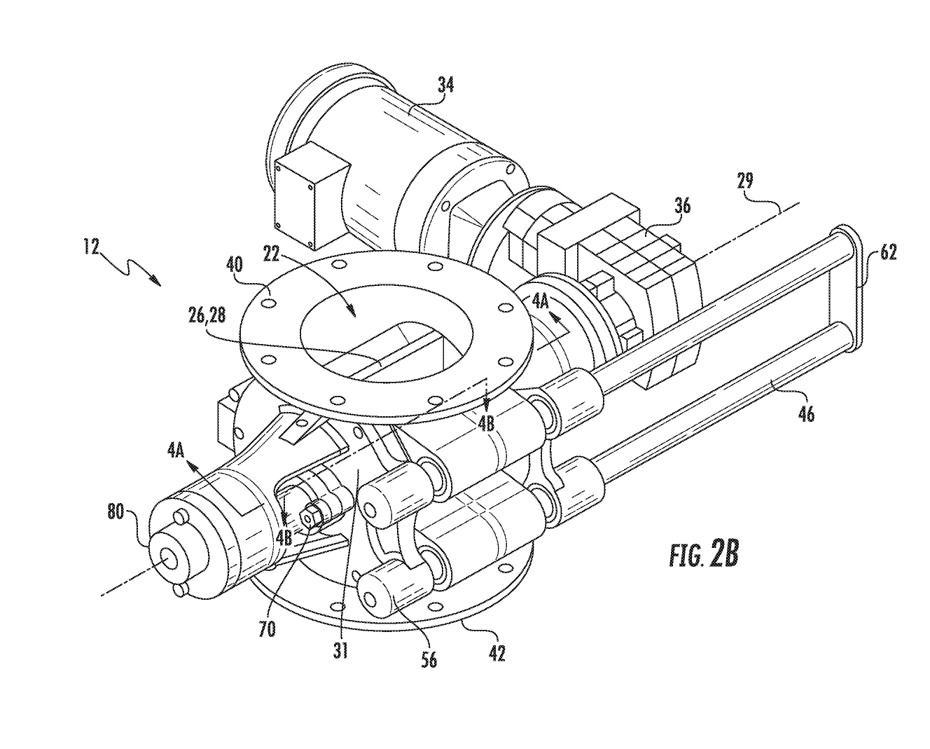

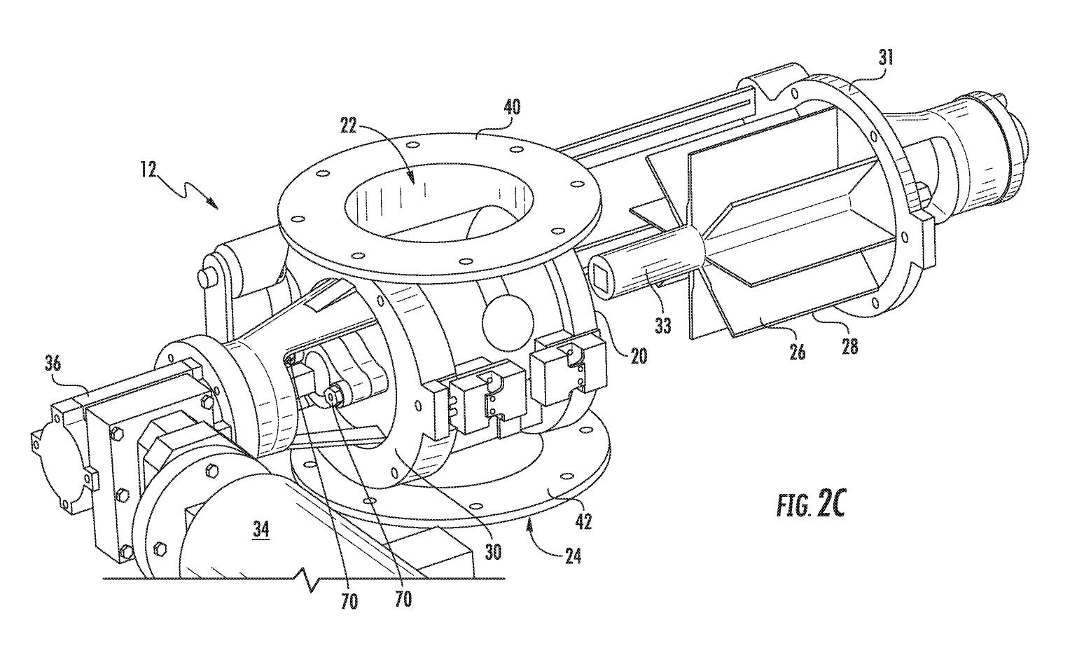

Referring now to FIGS. 2A-2C, the principal components of the rotary valve 12 of the present invention are depicted. The rotary valve 12 comprises a cylindrical housing 20 having a top opening 22 (e.g., inlet for the particulate matter) and bottom opening 24 (e.g., outlet for the particulate matter). Each said opening 22, 24 is provided with a flange, specifically a top flange 40 and a bottom flange 42, respectively, adapted to connect to other elements of the conveying system 10. A vaned rotor 26 provided with vanes 28 is positionable within the cylindrical housing 20, and captured by the drive side end plate 30 and the operator side end plate 31. The vaned rotor 26 is provided with shafts 32, 33 about which the vaned rotor 26 rotates. The drive side shaft 33 is suitable for engagement with a drive motor 34, acting through a transmission 36, which typically is designed to transform the motor 34 output rotational axis by 90°.

Central to the rotary valve 12 is a cylindrical housing 20 through which particulate material will ultimately flow. A storage vessel 14 for particulate matter, such as a hopper, is affixed to the top flange 40 of the cylindrical housing 20 utilizing threaded fasteners (not shown). Likewise, the discharge conduit 18 is affixed to the bottom flange 42, and is positioned to accept the discharge of particulate matter passing through the cylindrical housing 20. This material is conveyed through the cylindrical housing 20 by the movement of the vanes 28 as the vaned rotor 26 rotates about an axis of rotation 29 formed by the shafts 32, 33.

The housing 20 additionally includes two side openings that are sealed by the drive side end plate 30 or the operator side end plate 31. The vaned rotor 26 is insertable into the housing 20 through one or both of the side openings. The drive side end plate 30 is adapted to be secured, using threaded fasteners (not shown), to a drive side flange 52 of cylindrical housing 20, and is sealed in relation thereto by the drive side gasket 54. The drive side end plate 30 is provided with sockets 56 that capture the ends of slide rails 46. Corresponding sockets 56 are also formed in the operator side end plate 31. Slide rail bearings 48 are mounted in the sockets 56, as well as in the exterior of cylindrical housing 20, to facilitate the slidable movement of the operator side end plate 31 and the rotor 26 away from engagement with and into engagement with cylindrical housing 20. This ability of these components to be repositioned insures that the rotor 26 and other components herein described may be removed for inspection and service.

Seal sets 58 (e.g., comprising one or more annular, elastomeric seal members) are positioned in each of the end plates 30, 31 to form an annular elastomeric seal between the end plates 30, 31 and shafts 32, 33. The shafts 32, 33 each extend through apertures or holes in the end plates 30, 31 of the housing 20 and receive the seal sets 58 therearound in positions exterior to the cavity of the housing 20. A rotor drive 60 engages the drive side shaft 33 through the end plate 30, whereby operation of the drive motor 34 through the transmission 36 results in the rotation of the rotor 26, thereby maintaining the flow of particulate matter through the cylindrical housing 20. Drive support bearings 64 work in cooperation with the transmission 36 to provide support for the transmission 36. A rail stop 62 is secured to the ends of the slide rails 46 with fasteners 68, thereby limiting the range of travel of the rails 46 in relation to the drive side end plate 30 and the cylindrical housing 20, as well as the operator side end plate 31.

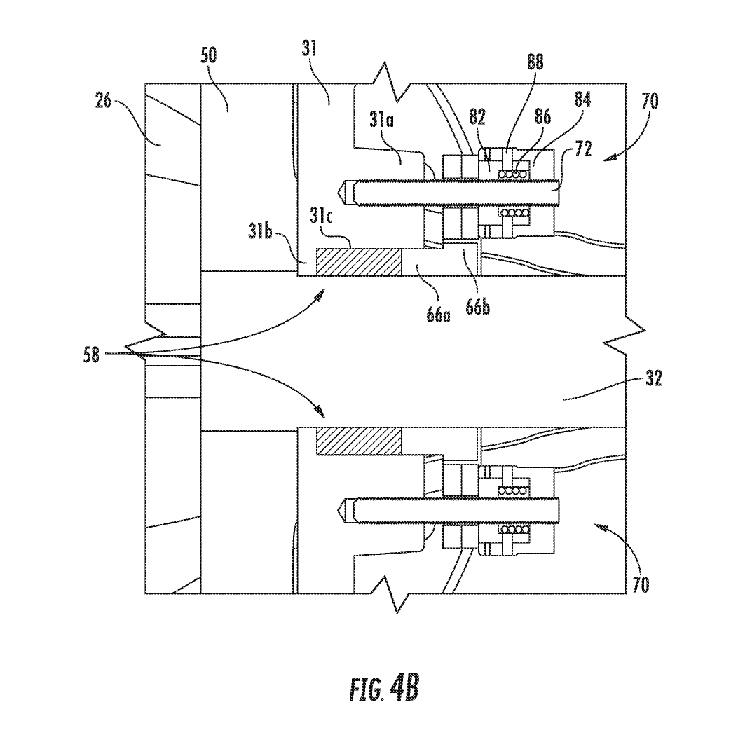

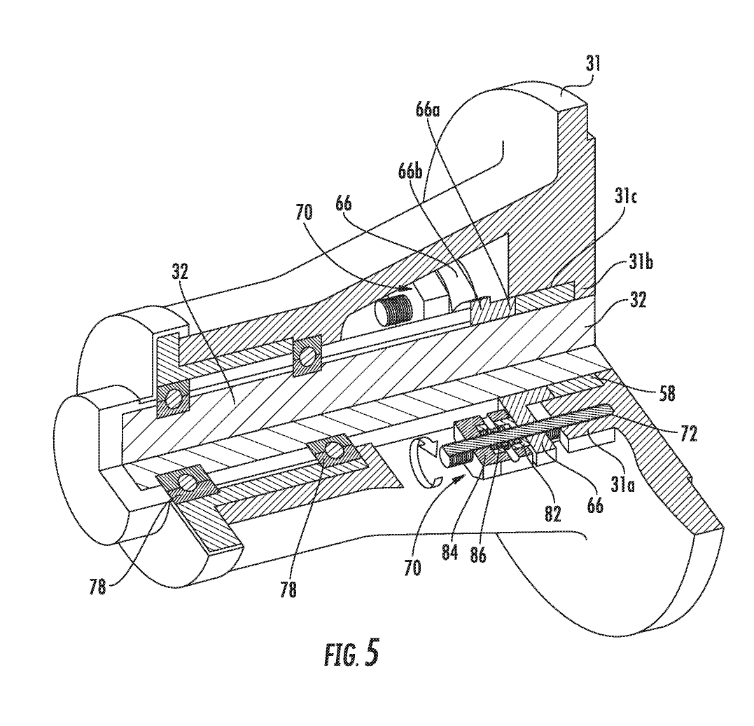

With continued reference to FIG. 2A-2C and 4A-5, it will be appreciated that the seal set 58 is positioned within a central cavity or recess 31c in the operator side end plate 31. A seal gland 66 (e.g., annular or compressing member) is then mounted to operator side end plate 31 utilizing threaded mounting studs 72, whereby the seal gland 66 captures the seal set 58 between the seal gland 66 and the end plate 31. A corresponding seal gland 66 and seal set 58 are positioned and configured similarly in the drive side end plate 30.

More particularly, each seal set 58 includes one or more annular, elastomeric seals (e.g., four annular seals, less, or more) that are positioned within the annular recess 31c in the operator side end plate 31 to surround and engage the operator side shaft 32. The seal set 58 may be provided as another type of seal or multiple seals sufficient for sealing against the shafts 32, 33. The seal gland 66 includes an annular segment 66a (e.g., annular or cylindrical portion) that extends into the annular recess 31c of the operator side end plate 31, so as to compress the seal set 58 between an annular flange 31b (e.g., housing flange) at an interior end of the operator side end plate 31. The annular flange 31b extends radially inward from the annular recess 31c to define the aperture through which the operator side shaft 32 extends.

The seal gland 66 additionally includes a radial flange 66b that extends radially outward from the annular segment 66a of the seal gland 66. The radial flange 66b of the seal gland 66 is configured to receive the fasteners 72 therein, which extend from an axial end face of the operator side end plate 31, such as from an axial protrusion 31a of the operator side end plate 31. For example, the radial flange 66b may form two ears that receive the fasteners 72 therein at positions opposite each other (e.g., 180 degrees apart about the axis of the operator side shaft 32). According to other embodiments, the radial flange 66b may form more ears and/or otherwise be configured to receive additional fasteners 72 circumferentially spaced substantially equally about the seal gland 66, the seal set 58, and/or the operator side shaft 32.As discussed in further detail below, each pressure cartridge 70 (e.g., spring-loaded cartridge or spring mechanism) is configured to engage the radial flange 66b (e.g., the ears) of the seal gland 66, so as to compress the seal set 58 within the annular recess 31c of the operator side end plate 31.

One or more of the seal set 58, the seal gland 66, the one or more pressure cartridges 70 (e.g., first, second, or additional pressure cartridges 70 or spring mechanisms), and the one or more fasteners 72 on each side of the rotary valve assembly 12 (i.e., the operator or the drive side) may be considered to cooperatively form a seal mechanism that seals one of the shafts 32, 33 to the housing 20 (e.g., to one of the end plates 30, 31 of the housing 20). The drive side end plate 30, the seal set 58, and the gland 66 on the drive side may be similarly configured to those similar components or assemblies on the operator side.

The pressure cartridges 70 of the present invention include threads engageable with the mounting studs 72. In the embodiment, a pair of pressure cartridges 70 is secured to opposing studs 72 adjacent to the cavity 31c on which the seal gland 66 is mounted. Support bearings 78 associated with the bearing support 79 provide a low friction support for shaft 32 in relation to end plate 31. A bearing cap 80 provides protective covering over the end support bearings 78 and the end of shaft 32. A plurality of securement handles 76 engage holes in the operator's side end plate 31 and mating holes in the operator side flange 50. The securement handles 76 are provided with grippable ends to permit the operator side end plate 31 and rotor 26 to be easily disconnected from the cylindrical housing 20 without the need for specialized tools.

The rotary valve 12, when assembled, is depicted in FIG. 2B. A study of this diagram will assist in the understanding of the operator's side end plate 31 engagement with the housing 20, while still being configured to remain in alignment with the housing 20 as the rails 46 slide in relation to the housing 20. In this configuration, either of the drive side or the operator side end plates 30, 31 may be separated from the housing 20 yet remain in alignment therewith by virtue of rails 46. For example, as shown in FIG. 2C, the rotary valve 12 is depicted in a service configuration in which the vaned rotor 26 is extracted from the housing 20 for inspection and/or service with the operator side end plate 31 having moved along the rails 46.

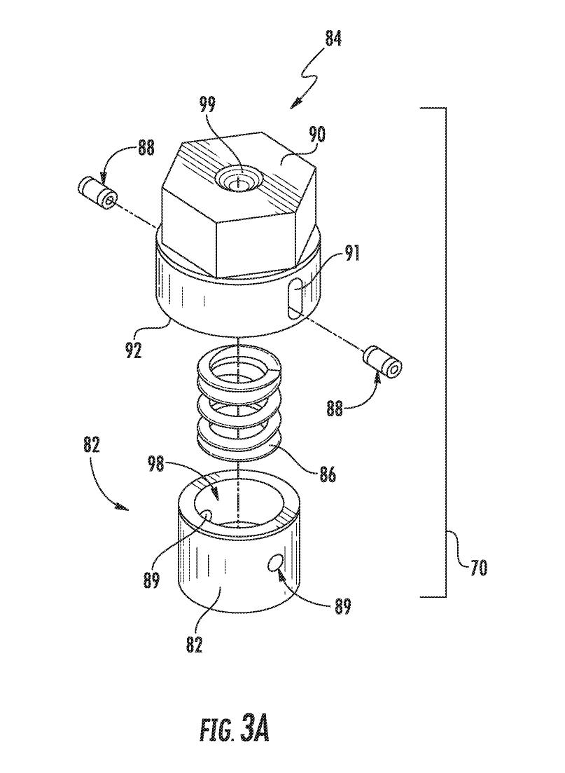

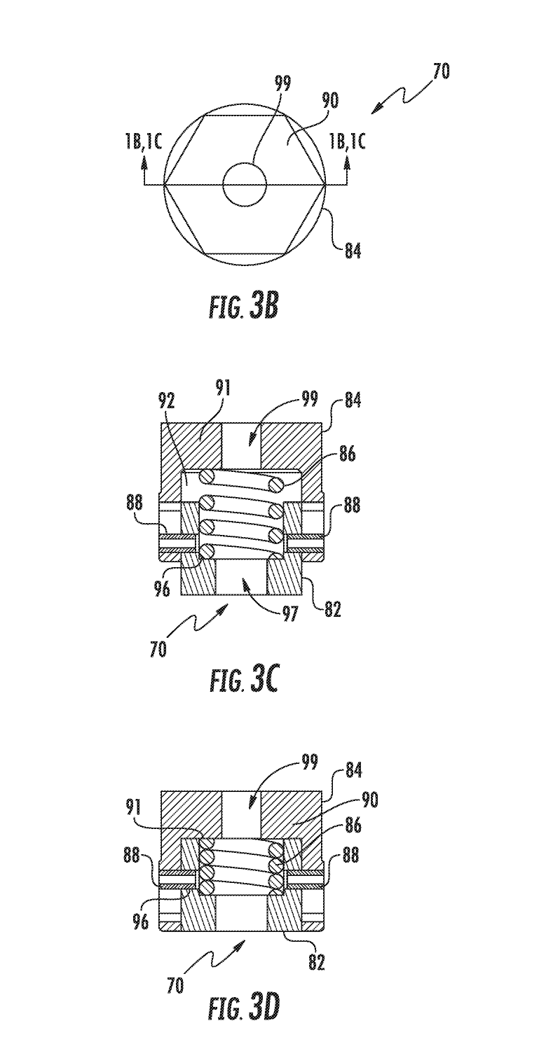

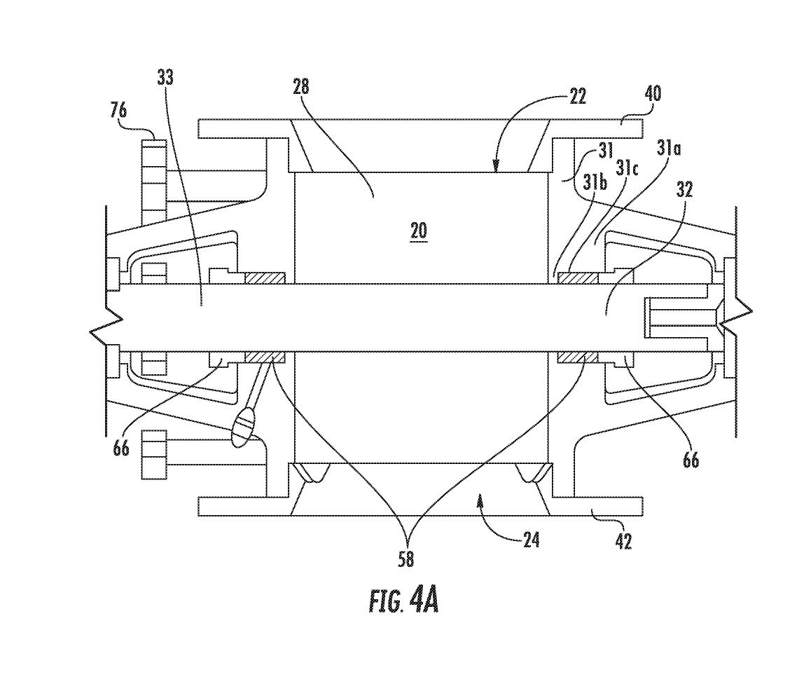

The detailed construction of the pressure cartridges 70 is depicted in FIGS. 3A-3D. Each pressure cartridge 70 comprises an inner cup 82 (e.g., first or inner member), an outer cup 84 (e.g., second or outer member), a helical spring 86, and a pair of spring pins 88. Broadly speaking, the outer cup 84 is configured to threadably engage one of the fasteners 72, the inner cup 82 engages the radial flange 66b of the seal gland 66, and the spring 86 is compressed between the outer cup 84 and the inner cup 82. In this manner, the inner cup 82 may apply a controllable axial force (i.e., parallel with the shaft 32 and/or the fastener 72) against the seal gland 66, which in turn applies a controllable axial force against the seal set 58 within the annular recess 31c of the operator side end plate 31. By providing multiple pressure cartridges 70 for each seal gland 66, such as two pressure cartridges 70 at 180 degrees apart about the seal gland 66 and/or seal set 58, the pressure cartridges 70 allow the seal gland 66 to apply substantially equal or even pressure across the seal set 58. That is, the one or more pressure cartridges 70 may each apply a controllable and/or predetermined force to the seal gland 66 based on compression of the spring 86, such that a predetermined force or pressure is applied against the seal set 58.

The inner cup 82 is a generally annular member that includes a central bore 97 and incorporates a cavity 98 (e.g., annular recess) which captures the helical spring 86. The central bore 97 has a smaller diameter than the cavity 98, so as to define a flange 96 that engages the helical spring 86. The central bore 97 additionally has a larger diameter than the fastener 72, which allows the inner cup 82 to move or displace axially relative to the fastener.

The outer cup 84 is another generally annular member that includes a threaded bore 99 and has a cylindrical cavity 92. The threaded bore 99 is configured to threadably engage one of the fasteners 72. The cylindrical cavity 84 has a complimentary inner diameter, corresponding to the outer diameter of the inner cup 82. In this fashion, the inner cup 82 slidably fits within the outer cup cavity 92. The threaded bore 99 has a smaller diameter than the cylindrical 92, so as to form a flange 91 that engages the spring 86. The spring 86 is captured between the flanges 91, 96 of the inner cup 82 and the outer cup 84, so as to be compressible therebetween.

The inner cup 82 is provided with diametrically opposed through holes 89. Likewise, outer cup 84 is provided with diametrically opposed slide openings 91. The pair of spring pins 88 passes through slide openings 91, and are configured to slide therein in a direction parallel with axes of the cylindrical cavity 92 and/or the shafts 32, 33 and fasteners 72 but generally perpendicular to axes of the pins 88. The spring pins 88 additionally engage holes 89 in the inner cup 82, and are fixed in an axial position on the inner cup 82. In this manner, the inner cup 82 is configured to slide axially relative to the outer cup 84 in a limited range of motion. That is, one end of the range of movement occurs when the spring pins 88 engage ends of the slide openings 91 of the outer cup 84, which occurs when the spring 86 is maximally decompressed. The spring 86 may remain in compression between the flanges 91, 96 of the outer and inner cups 84, 82, respectively, when maximally decmpressed in the cartridge 70. The other end of the range of movement occurs when an inner end of the inner cup 82 engages the flange 91 of the outer cup 84 and/or an outer end of the inner cup 82 becomes coextensive with an end of the outer cup 84 opposite the threaded bore 99. This occurs when the spring 86 is maximally compressed within the cartridge 70.

The outer cup 84 is further provided with a tool-engaging section, such as a hexagonal head 90, to facilitate engagement of the cartridge 70 with a conventional hex wrench or similar tool. More particularly, the outer cup 84 also comprises the threaded bore or opening 99, with thread diameter and pitch complimentary to the diameter and pitch of mounting studs 72 affixed to operator's side end plate 31. Each pressure cartridge 70 is, thereby, threadably affixed to a complimentary and corresponding mounting stud 72, thereby securing each ear of one of the seal glands 66 to one mounting stud 72.

As shown in FIGS. 3D-5, it will be appreciated that as the pressure cartridge 70 is threadably advanced along the threaded length of mounting stud 72, the bottom of outer cup 84 will engage the radial flange 66b (e.g., one of the ears) of the seal gland 66, thereby urging the seal gland 66 toward the outer side of operator side end plate 31 with a force commensurate to compression of the spring 86. The seal gland 66 thereby captures the seal set 58 axially between the annular segment 66a of the seal gland 66 and the radial flange 31b of the operator side end plate 31. Once the bottom of outer cup 84 is in contact with the surface of the ear of seal gland 66 and/or the inner end of the inner cup 82 engages the flange 91 of the outer cup 84, the seal gland 66 may be further urged toward operator side end plate 31, exerting pressure on the seal set 58. When pressure cartridge 70 is fully energized (e.g., tightened, as shown in FIG. 3D), the force exerted by spring 86 will maintain a relatively constant pressure against seal gland 66.

It will be appreciated that the exertion of axial force or pressure on seal gland 66 translates to increased lateral pressure being exerted by the seal set 58. In other words, increased lateral pressure on the gland 66 (i.e., in an axial direction) increases the expansion of the seal set 58 (i.e., in radial directions), which urges the seal set 58 elements against the outer circumference of the shaft 32 and the inner circumference of the recess or cavity 31c in the end plate 31 in which the seal set 58 is positioned. It should be noted that directional terminology such as upper, lower, top, and bottom, which are used in conjunction with the pressure cartridges 70, are for reference only for ease of understanding, since the pressure cartridges 70 may be installed in different orientations in the valve assembly 12 (e.g., with a the fasteners 72 extending horizontally therethrough, as shown in FIGS. 2A-2C).

The design of the cartridge 70 permits the operator of the equipment to easily visualize the amount of spring force being exerted against the seal gland 66 by measuring the height (e.g., axial displacement) of the inner cup 82 which is visible between the lower edge of the outer cup 84 and the surface of the seal gland 66 and ultimately the seal set 58. That is, axial displacement of the inner cup 82 and the outer cup 84 relative to each other provides a visual indication of the force applied by the pressure cartridge 70 to the gland 66. Further, by virtue of the fact that the spring 86 is of a relatively short length, the amount of pressure being exerted by the cartridge 70 against the seal gland 66 remains substantially constant. This allows for precise control over pressure, and specifically, the amount of pressure needed for different seal materials and types. The net result is increased seal life and reduction in uneven seal wear. In the preferred embodiment, the length and modulus of the spring 86 are selected so that the fully compressed length of spring 86 is between approximately 55 and 75 percent (e.g., approximately 65 percent) of the uncompressed length of said spring 86.

As referenced above, the combination of the seal set 58, the seal gland 66, and the cartridge 70, which collectively form a seal mechanism, is assembled on both drive plates 30 and 31, thereby providing sealing on shafts 32 and 33, as shown in FIGS. 2B and 2C.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. In a rotary valve of a type configured to control flow of particulate matter from a storage source into a conduit under pneumatic pressure, said valve further comprising a cylindrical housing, opposing end plates partially enclosing said cylindrical housing, and a vaned rotor having opposing shafts protruding through annular seals provided in said end plates, the improvement comprising at least one spring-loaded cartridge adapted to exert a pre-determined pressure against said seals.

2. The rotary valve of claim 1, wherein said spring-loaded cartridge further comprises a helical spring having a fully compressed length equal to approximately 65 percent of its uncompressed length.

3. The rotary valve of claim 2, wherein said spring-loaded cartridge further comprises an accessible upper tool-engaging section, whereby said cartridge may be rotated by a tool.

4. The rotary valve of claim 1, wherein said cartridge further comprises an accessible upper tool-engaging section, whereby said cartridge may be rotated by a tool.

5. A rotary valve for controlling flow of particulate matter from a source to a conduit, the rotary valve comprising:
a housing having an inlet, an outlet positioned below the inlet, and a cavity between the inlet and the outlet;
a rotor positioned in the cavity of the housing, the rotor having a shaft about which the rotor rotates within the cavity; and
a seal mechanism comprising a seal and one or more spring mechanisms that include a spring, wherein each spring mechanism is rotatable about an axis to compress the spring axially to urge the seal radially between the shaft and the housing.

6. The rotary valve of claim 5, wherein the shaft protrudes out of the cavity into a recess defined by the housing, the seal surrounds the shaft, and the seal is compressed in a direction parallel with the axis to be urged radially outward against the housing and radially inward against the shaft.

7. The rotary valve of claim 6, wherein the seal mechanism further comprises an annular member that surrounds the shaft and engages the seal, the housing defines a flange protruding radially inward from the recess, and the seal is compressed axially between the annular member and the flange.

8. The rotary valve of claim 7, wherein the spring applies an axial force to the annular member.

9. The rotary valve of claim 8, wherein each spring mechanism includes an outer member and an inner member that slides within the outer member and between which the spring is compressed, wherein the outer member is threaded to a fastener of the housing and the inner member engages the annular member.

10. The rotary valve of claim 9, wherein each spring mechanism further comprises one or more pins received in apertures of the outer member and the inner member to limit relative movement between the inner member and the outer member.

11. The rotary valve of claim 5, wherein the seal mechanism further includes an annular member, and the one or more spring mechanisms include a first spring mechanism and a second spring mechanism;
wherein the annular member engages the seal in an axial direction, and the first spring mechanism and the second spring mechanism engage the annular member in an axial direction and are spaced equally about the annular member.

12. The rotary valve of claim 11, wherein the annular member includes an annular portion that engages the seal and a radial flange that is engaged by the first spring mechanism and the second spring mechanism.

13. The rotary valve of claim 12, wherein the radial flange defines a first ear engaged by the first spring mechanism and a second ear engaged by the second spring mechanism.

14. The rotary valve of claim 12, wherein the spring of the first spring mechanism and the spring of the second spring mechanism are compressed a substantially equal amount to axial forces substantially equally to the annular member.

15. The rotary valve of claim 11, wherein each spring mechanism includes an outer member and an inner member that slides within the outer member to compress the spring therebetween, wherein the outer member is coupled to the housing with a threaded fastener and the inner member engages the annular member.

16. The rotary valve of claim 5, wherein the housing includes a side opening and an end plate that seals the side opening, wherein the shaft protrudes through an aperture of the end plate, and the seal mechanism seals the aperture.

17. The rotary valve of claim 16, wherein the aperture defines a recess and a radial flange, and the seal is compressed axially between the spring mechanism and the radial flange to be urged radially outward against a wall of the recess and radially inward against the shaft.

18. A conveying system for particulate matter, the conveying system comprising:
a rotary valve;
a storage vessel coupled to and positioned above the rotary valve, the storage vessel being configured to contain particulate matter and supply the particulate matter to the rotary valve; and
a conduit coupled to and positioned below the rotary valve, the conduit being configured to receive the particulate matter from the rotary valve;
wherein the rotary valve comprises:
a housing having a top opening for receiving the particulate matter from the storage vessel, a bottom opening for supply the particulate matter to the conduit, and a cavity;
a rotor having a shaft and a plurality of radially extending vanes, the rotor being configured to rotate about the shaft; and
a seal mechanism that seals the shaft to the housing, wherein the seal mechanism includes a seal and a plurality of spring mechanisms distributed about the seal to compress the seal in an axial direction with substantially even force to urge the seal radially outward against the housing and radially inward against the shaft.

19. The conveying system according to claim 18, wherein seal mechanism further includes an annular member that engages the seal in an axial direction, and the housing further includes a side opening and an end plate that seals the side opening, the end plate having a recess in which the annular member, the seal, and the shaft are positioned; and
wherein each spring mechanism includes a first member and a spring, and the first member is threadably attached to a fastener of the end plate to axially compress the spring to apply the force against the annular member.

20. The conveying system according to claim 19, wherein each spring mechanism further includes a second member that is configured to slide relative to the first member and compress the spring therebetween; and
wherein the end plate includes a housing flange at an interior end of the recess, and the annular member includes an annular segment and a radially extending flange, wherein the annular segment is received within the recess to compress the seal between the housing flange, and the second member of each spring mechanism engages the radially extending flange.
